(19) United States
(12) Patent Application Publication
(10) Pub. No.: US 2006/0007515 A1
(43) Pub. Date: Jan. 12, 2006

(54) Surface lubrication in microstructures

(76) Inventors: Dmitri Simonian, Sunnyvale, CA (US); John Porter, Berkeley, CA (US)

Correspondence Address: REFLECTIVITY, INC., 350 POTRERO AVENUE, SUNNYVALE, CA, 94085, US

(21) Appl. No.: 10/890,352

(22) Filed: Jul. 12, 2004

Related U.S. Application Data
(63) Continuation-in-part of application No. 10/713,671, filed on Nov. 13, 2003.

(51) Int. Cl. G02F 1/03

(52) U.S. Cl. 359/245

(57) ABSTRACT

Lubricants for lubricating surfaces of microelectromechanical devices are disclosed. Specifically, the lubricants can be applied to the contacting surfaces of the microelectromechanical devices so as to remove stiction of the contacting surfaces.

### CROSS-REFERENCE TO RELATED APPLICATIONS

The present patent application is a continuation-in-part of U.S. patent application Ser. No. 10/713,671 to Simonian et al, filed Nov. 13, 2003, the subject matter being incorporated herein by reference.

### TECHNICAL FIELD OF THE INVENTION

The present invention is related generally to the art of microstructure, and, more particularly, to lubricants used in lubricating surfaces of the microstructures.

### BACKGROUND OF THE INVENTION

Microstructures, such as microelectromechanical devices (e.g. accelerometers, DC relay and RF switches, optical cross connects and optical switches, microlenses, reflectors and beam splitters, filters, oscillators and antenna system components, variable capacitors and inductors, switched banks of filters, resonant comb-drives and resonant beams, and micromirror arrays for direct view and projection displays) have many applications in basic signal transduction. For example, a spatial light modulator based on a microelectromechanical device steers light in response to electrical or optical signals. Such a modulator can be a part of a communication device or an information display.

A major factor that limits the reliability and widespread use of microelectro-mechanical devices is adhesion. Adhesion is a result of the dominance of surface and interfacial forces, such as capillary, chemical bonding, electrostatic, and van der Waals forces, over mechanical forces which tend to separate microelectromechanical components. When mechanical restoring forces cannot overcome adhesive forces, the microelectromechanical devices are said to suffer from stiction. Stiction failures in contacting microstructures, such as micromirror devices, can occur after the first contacting event (often referred to as initial stiction), or as a result of repeated contacting events (often referred to as in-use stiction). Initial stiction is often associated with surface contamination (e.g., residues of bonding materials or photoresist), or with high energy of contacting surfaces (e.g., clean oxidized silicon or metallic surfaces). For the case of in-use stiction, each time one part of the microstructure (e.g. mirror plate of a micromirror device) touches the other (e.g. stopping mechanism) or the substrate, the contact force grows and ultimately becomes too large for the restoring force to overcome. In this case, the device remains in one state indefinitely. This phenomenon can arise from a variety of underlying mechanisms, such as contact area growth, creation of high-energy surface by micro-wear, surface charge separation etc. An approach to reduce stiction is to lubricate surfaces of microstructures.

### SUMMARY OF THE INVENTION

The objects and advantages of the present invention will be obvious, and in part appear hereafter and are accomplished by the present invention that provides a method and apparatus for lubricating contacting microelectromechanical devices. Such objects of the invention are achieved in the features of the independent claims attached hereto. Preferred embodiments are characterized in the dependent claims.

### BRIEF DESCRIPTION OF DRAWINGS

While the appended claims set forth the features of the present invention with particularity, the invention, together with its objects and advantages, may be best understood from the following detailed description taken in conjunction with the accompanying drawings of which:

FIG. 1 is a perspective view of an exemplary microstructure device package having a microstructure device and a container that comprises a lubricant according to an embodiment of the invention;

FIG. 2 is a perspective view an exemplary micromirror array device;

FIG. 3 is a perspective view of an exemplary micromirror device of the micromirror array in FIG. 2;

FIG. 4 and FIG. 5 are exemplary lubricates useable in the embodiments of the present invention;

FIGS. 6a to 6d are cross-section views of the micromirror in FIG. 3 during an exemplary fabrication process;

FIGS. 7 and 8 are cross-section views of the micromirror in FIGS. 6a to 6d after removal of the sacrificial layers; and

FIG. 9 is an exemplary display system having a spatial light modulator.

### DETAILED DESCRIPTION OF THE EMBODIMENTS

The present invention discloses lubricant materials for use in lubricating microelectromechanical devices having contacting surfaces.

In an embodiment of the invention, a microelectromechanical device is disclosed. The device comprises: a movable element; and a non-deflectable element; wherein a contacting surface of the movable and non-deflectable element comprises a layer of a material that is a mono-ether or thio-ether.

In another embodiment of the invention, a microelectromechanical device is disclosed. The device comprises: a movable element; and a non-deflectable element; wherein a contacting surface of the movable and non-deflectable element comprises a layer of a material that is amine, phosphine, or borane.

In yet another embodiment of the invention, a microelectromechanical device is disclosed. The device comprises: a movable element; and a non-deflectable element; wherein a contacting surface of the movable and non-deflectable element comprises a layer of a material that is a fluorinated organic material containing a ring structure.

In yet another embodiment of the invention, a microelectromechanical device is disclosed. The device comprises: a movable element; and a non-deflectable element; wherein a contacting surface of the movable and non-deflectable element comprises a layer of a material that is a silane having four substituent groups, R₁R₂R₃R₄Si, wherein R₁ to R₄ are bonded to Si and are independently alkyl groups.

In yet another embodiment of the invention, a microelectromechanical device package is disclosed. The package comprises: a package substrate having a supporting surface on which a microelectromechanical device is held; and a light transmissive lid in connection with the package substrate such that the microelectromechanical device can be sealed within a space formed by the package substrate and the lid; wherein the microelectromechanical device comprises a movable element; and a non-deflectable element; wherein a contacting surface of the movable and non-deflectable element comprises a layer of a material that is a mono-ether or thio-ether.

In yet another embodiment of the invention, a microelectromechanical device package is disclosed. The package comprises: a package substrate having a supporting surface on which a microelectromechanical device is held; and a light transmissive lid in connection with the package substrate such that the microelectromechanical device can be sealed within a space formed by the package substrate and the lid; wherein the microelectromechanical device comprises: a movable element; and a non-deflectable element; wherein a contacting surface of the movable and non-deflectable element comprises a layer of a material that is amine, phosphine, or borane.

In yet another embodiment of the invention, a microelectromechanical device package is disclosed. The package comprises: a package substrate having a supporting surface on which a microelectromechanical device is held; and a light transmissive lid in connection with the package substrate such that the microelectromechanical device can be sealed within a space formed by the package substrate and the lid; wherein the microelectromechanical device comprises: a movable element; and a non-deflectable element; wherein a contacting surface of the movable and non-deflectable element comprises a layer of a material that is a fluorinated organic material containing a ring structure.

In yet another embodiment of the invention, a microelectromechanical device package is disclosed. The package comprises: a package substrate having a supporting surface on which a microelectromechanical device is held; and a light transmissive lid in connection with the package substrate such that the microelectromechanical device can be sealed within a space formed by the package substrate and the lid; wherein the microelectromechanical device comprises: a movable element; and a non-deflectable element; wherein a contacting surface of the movable and non-deflectable element comprises a layer of a material that is a silane having four substituent groups, R₁R₂R₃R₄Si, wherein R₁ to R₄ are bonded to Si and are independently alkyl groups.

In yet another embodiment of the invention, a projection system is disclosed. The system comprises: an illumination system providing light for the system; a spatial light modulator having an array of micromirrors, each micromirror comprising: a deflectable reflective mirror plate; and a stopping mechanism; wherein a contacting surface of the mirror plate and the stopping mechanism comprises a layer of a material that is a mono-ether or thio-ether.

In yet another embodiment of the invention, a projection system is disclosed. The system comprises: an illumination system providing light for the system; a spatial light modulator having an array of micromirrors, each micromirror comprising: a deflectable reflective mirror plate; and a stopping mechanism; wherein a contacting surface of the mirror plate and the stopping mechanism comprises a layer of a material that is amine, phosphine, or borane.

In yet another embodiment of the invention, a projection system is disclosed. The system comprises: an illumination system providing light for the system; a spatial light modulator having an array of micromirrors, each micromirror comprising: a deflectable reflective mirror plate; and a stopping mechanism; wherein a contacting surface of the mirror plate and the stopping mechanism comprises a layer of a material that is a fluorinated organic material containing a ring structure.

In yet another embodiment of the invention, a projection system is disclosed. The system comprises: an illumination system providing light for the system; a spatial light modulator having an array of micromirrors, each micromirror comprising: a deflectable reflective mirror plate; and a stopping mechanism; wherein a contacting surface of the mirror plate and the stopping mechanism comprises: a movable element; and a non-deflectable element; wherein a contacting surface of the movable and non-deflectable element comprises a layer of a material that is a silane having four substituent groups, R₁R₂R₃R₄Si, wherein R₁ to R₄ are bonded to Si and are independently alkyl groups.

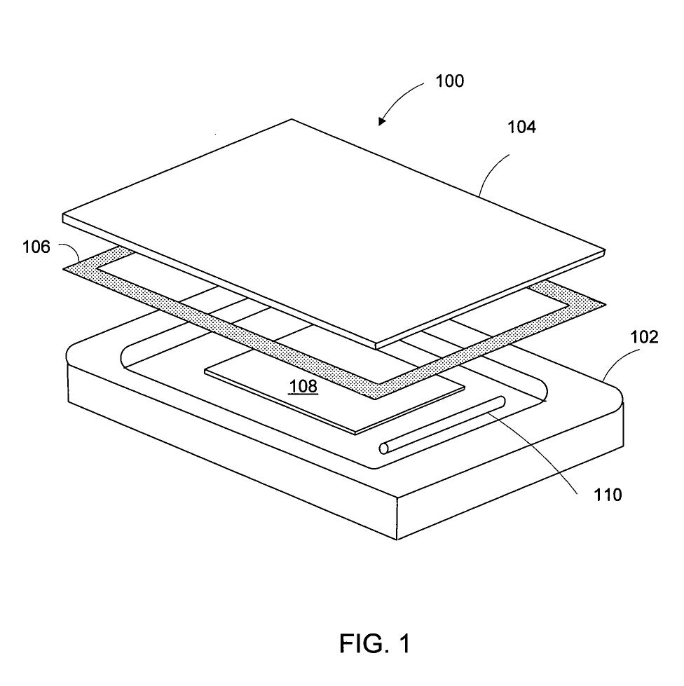

Turning to the drawings, FIG. 1 illustrates a perspective view of an exemplary microstructure in a package in which embodiments of the present invention can be implemented. Microstructure 108 is disposed on package substrate 102 of microstructure package 100. Package cover 104 is bonded to the package substrate via sealing layer 106. The package substrate and the package cover may also be hermetically sealed, but not required. In fact, there is a variety of ways to package the microstructure, as set forth in U.S. patent applications: 1) Ser. No. 10/852,981 to Tam, filed May 24, 2004; 2) Ser. No. 10/810,076 to Dunphy, filed Mar. 26, 2004; 3) Ser. No. 10/811,449 to Dunphy, filed Mar. 26, 2004; 4)Ser. No. 10/698,656 to Tarn, filed Oct. 30, 2003; and 5)Ser. No. 10/443,318 to Tarn, field May 22, 2003, the subject matter of each being incorporated herein by reference.

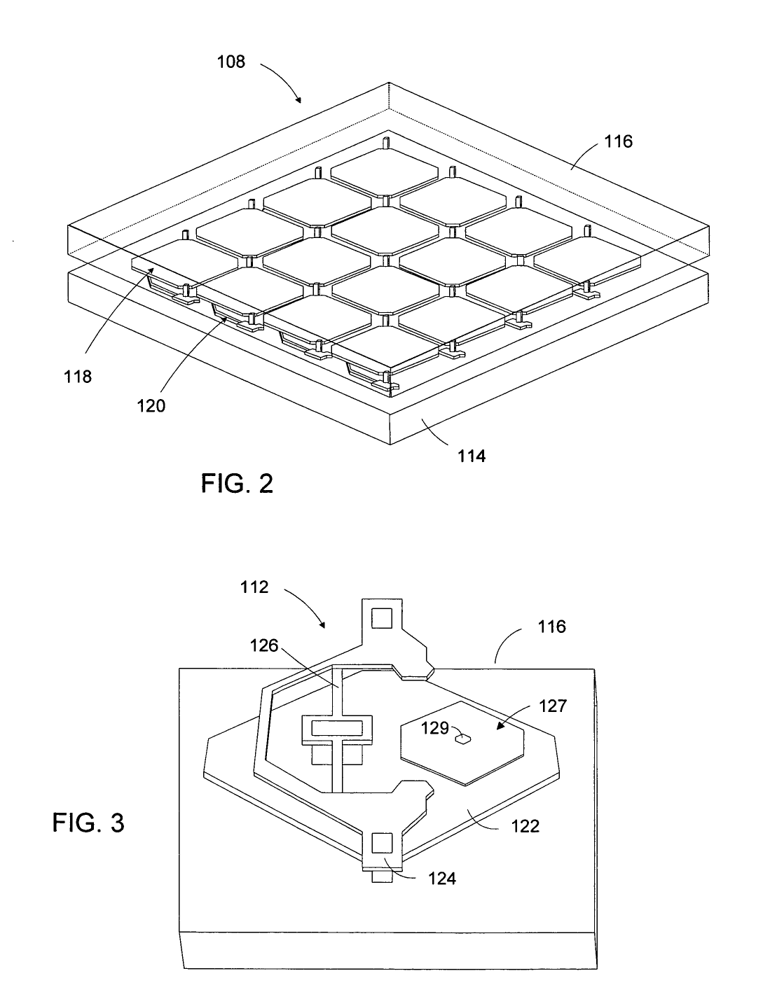

The microstructure device can be of a variety of types, such as micromirrors, micromirror array devices, micro-engines, micro-sensors, LCDs, LCOS, CCDs, and micro-actuators. As a way of example, a portion of an exemplary micromirror-based spatial light modulator is illustrated in FIG. 2. Referring to FIG. 2, spatial light modulator 108 comprises an array of reflective deflectable mirror plates 118 formed on substrate 116 which is visible light transmissive. For deflecting the mirror plates, an array of electrodes and circuitry is formed on semiconductor substrate 114. In operation, the mirror plates of the array are individually addressed and deflected by electrostatic fields between the mirror plates and electrodes. The mirror plates reflect incident light onto different spatial directions in accordance with input signals, such as image or video signals so as to display the image.

The micromirrors may take any desired shapes and configurations. A portion of an exemplary micromirror in FIG. 2 is illustrated in FIG. 3. Referring to FIG. 3, the micromirror comprises hinge 126 that is held by two posts 124 on the glass substrate 116. A reflective mirror plate 122 is attached to the hinge such that the mirror plate can rotate relative to the glass substrate in response to the electrostatic field established between the mirror plate and the electrode (not shown) associated with the mirror plate. In this particular example, the mirror plate is attached to the hinge such that the mirror plate can rotate asymmetrically -that is the mirror plate can rotate to a larger angle in one direction than in the opposite direction. This asymmetric rotation is achieved by attaching the mirror plate to the hinge such that the attachment point is neither along a diagonal of the mirror plate nor at the center of the mirror plate. Moreover, the hinge is disposed such that the hinge is parallel to but offset from a diagonal of the mirror plate when viewed from the top. In fact, other configurations can be employed. For example, the mirror plate can be any other desired shape. The hinge and the mirror plate can be arranged such that the mirror plate rotates symmetrically in both directions. As an alternative feature of the embodiment of the invention, extension plate 127 can be formed on the mirror plate and connected to the mirror plate via extension post 129. With the extension plate, electrical coupling between the mirror plate and the external electrostatic field can be enhanced, as set forth in U.S. patent application Ser. No. 10/613,379 to Patel, filed Jul. 3, 2003, the subject matter being incorporated herein by reference.

Rather than formed on separate substrates, the micromirrors and electrodes can be formed on the same substrate, such as a semiconductor substrate. In another embodiment of the invention, the micromirror substrate can be formed on a transfer substrate that is light transmissive. Specifically, the micromirror plate can be formed on the transfer substrate and then the micromirror substrate along with the transfer substrate is attached to another substrate such as a light transmissive substrate followed by removal of the transfer substrate and patterning of the micromirror substrate to form the micromirror.

In operation, the mirror plates of the spatial light modulator may suffer from in-use stiction and thus cause device failure. For this reason, the surfaces of the mirror plates, as well as other desired members of the micromirror device is lubricated with selected lubricants before delivering to customers.

In accordance with the invention, the lubricant is preferably a material that does not form covalent bands with the target surface. It can be in a liquid state at the device operation temperature, such as 70° C. degrees or less, or 50° C. or less. The surface tension of the lubricant on the surface is desired to be low, such as 50 dynes/cm or less, or 20 dynes/cm or less. The lubricant may have a high boiling point (e.g. 150° C. or higher, or 200° C. or higher) or low vapor pressure such that the lubricant does not condense at low temperature or fully evaporate at high temperatures (e.g. 50° C. or more, or 70° C. or more, or even 200° C. or more) (the high temperature refer to the storage and operating range of the micromirror device). The lubricant is desired to be stable at a high temperature, such as up to 200° C. The viscosity of the lubricant in liquid phase can be of from 1 cP to 100 cP. Moreover, it is desired that the selected lubricant is able to form a physisorbed layer with a thickness of around 3 nm or less at a low partial pressure.

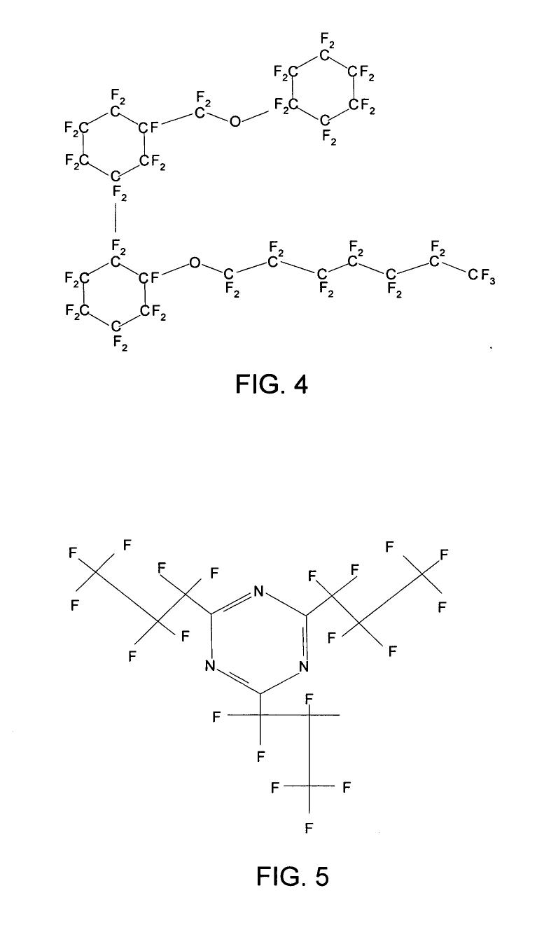

According to the invention, the lubricant can be a mono-ether or thio-ether (which can be unfluorinated, partially fluorinated, or perfluorinated), an amine, a phosphine, a borane material, a fluorinated organic material containing a ring structure (e.g. triazines), or a tetralkylsilane having four substituent groups, R₁R₂R₃R₄Si, wherein R₁ to R₄ are bonded to Si and are independently alkyl groups each preferably having 1 to 6 carbons. It is preferred that one of R₁ to R₄ groups is partially or fully fluorinated. The alkyl groups, R₁ to R₄ may or may not be that same, but preferably not labile, e.g. not reactive (e.g. do not hydrolyze). Examples include tetraperfluoroalkylsilanes such as perfluorinated tetramethylsilanes. For example, the lubricant can be a straight-chain fluorocarbon represented by F₃C—(CF₂)ₙ—CF₃, wherein n can be 4, 5 (e.g. FC-84, a product from Aka), 6 (e.g. a product from Exfluor), 7 (e.g. a product from Exfluor), and 8 (e.g. a product from Exfluor). As another example, the lubricant can be a perfluoroamine CF₃ (CF₂ₙ)₃N, wherein n can be 3 (i.e. perfluorotributylamine, e.g. FC-43, a product from Aka), 4(e.g. FC-70, a product from Aka), and 5 (i.e. perfluorotrihexylamine, e.g. FC-71, a product from 3M). As yet another example, the lubricant can be a perfluorocarbon with a ring structures, such as perfluorodecalin C₁₀F₁₈ (e.g. a product from Aldrich), perfluoromethyldecalin C₁₁F₂₀ (e.g. a product from Alfa Aesar), perfluoroperhydrophenil C₁₂F₂₂ (e.g. a product from Interchim), perfluoroperhydrofluorene C₁₃F₂₂ (e.g. a product from Interchim), perfluorotetradecahydrophenanthrene C₁₄F₂₄ (e.g. FC-5311, a product from Aka), or perfluorophenanthrene C₁₄F₂₄ (e.g. a product from SciInstrSvcs). As yet another example, the lubricant can be ring-structure perfluorocarbon with one or more oxygen linkage between rings, such as C₁₂F₂₄O, and single cycloether, as illustrated in FIG. 4. Alternatively, the lubricant may have fluorocarbon chains attached to a triazine ring, such as C₁₂F₂₁N₃, C₂₄F₄₅N₃ and C₃₀F₅₇N₃. The lubricant can also be a perfluorinated hydrocarbon having 20 carbons or less, such as alkanes, amines, alcohols, ethers, triazines and glycols.

The lubricant may be mixed with a diluent to form a lubricant solution. The lubricant is desired to be in a liquid phase at room temperature. For example the boiling point of the lubricant can be 30° C. or higher and/or the melting point is 10° C. or lower. The diluent may have a high vapor pressure at room temperature relative to the lubricant such that it does not condense on the target surface. Moreover, it is desired that the diluent is chemically stable at a temperature of 200° C. or higher. An exemplary diluent is a perfluorinated hydrocarbon having 20 carbons or less.

The selected lubricant can be applied to the desired surfaces in many ways. For example, the lubricant can be held by a container that is disposed within the microstructure package, such as container 110 in FIG. 1. The lubricant evaporates from an opening of the container and contacts the desired surfaces to be lubricated. Alternatively, the selected lubricant can be disposed on a substrate of the microstructure package, as set forth in U.S. patent application “Microelectromechanical Devices with Lubricants and Getters Formed Thereon” to Dunphy, Ser. No. 10/810,079, filed Mar. 26, 2004, the subject matter being incorporated herein by reference.

The selected lubricants of the present invention are useful for lubricate surfaces of many type of materials, such as light reflecting materials for mirror plates (e.g. Al, Ti AlSiCu, and TiAl) and materials for stoppers (e.g. Al, Ir, titanium, titanium nitride, titanium oxide(s), titanium carbide, TiSiNₓ, TaSiNₓ, TiNi, and SiNi or other ternary and higher compounds) that contact with the mirror plate during operation. Other materials for the surfaces may comprise materials that are predominantly intermetallic compounds that are further strengthened by addition of one or more strengthen materials, such as O and N. In this situation, the surface material comprises at least 60 atomic % or more, or 80 atomic % or more, or 90 atomic % or more, or 95 atomic % or more of the intermetallic material. It is further preferred that the intermetallic compound comprises a transition metal, as set forth in U.S. patent applications Ser. No. 10/805,610, filed Mar. 18, 2003; and Ser. No. 10/402,777 filed Mar. 28, 2003, the subject matter of each being incorporated herein by reference.

The above exemplary lubricants are chemicals that do not covalently bond to the surfaces of the microelectromechanical devices and are self-healing. Before applying one or more of these lubricants, the target surfaces can be coated with a chemical material that covalently bonds to the target surface such as one that forms a monolayer on the target surface, such as a self-assembled material. Exemplary such materials are: fatty acids (e.g. long-chain n-alkanoic acid), organosilanes, organosulfur compounds (e.g. alkanethiolates, thiophenol, thiocarbamate and mercaptopyridine), alkyl halides, multilayers of organophosphates, perfluoropolyethers or carboxylate perfluoropolyethers, and fluorocarbons. Exemplary organosilanes include alkylhalosilanes, such as chlorotrimethylsilane, alkylalkoxysilanes and alkylaminosilanes. The coating agent can also be a carboxylic acid material having the formula CF₃(CF₂)ₐ(CH₂)_{b}COOH, wherein a is greater than or equal to 0, and b is greater than or equal to 0.

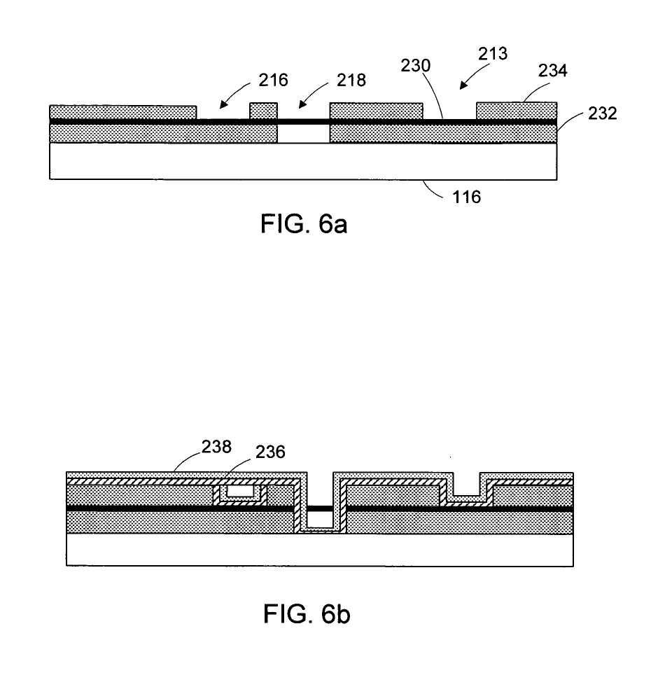

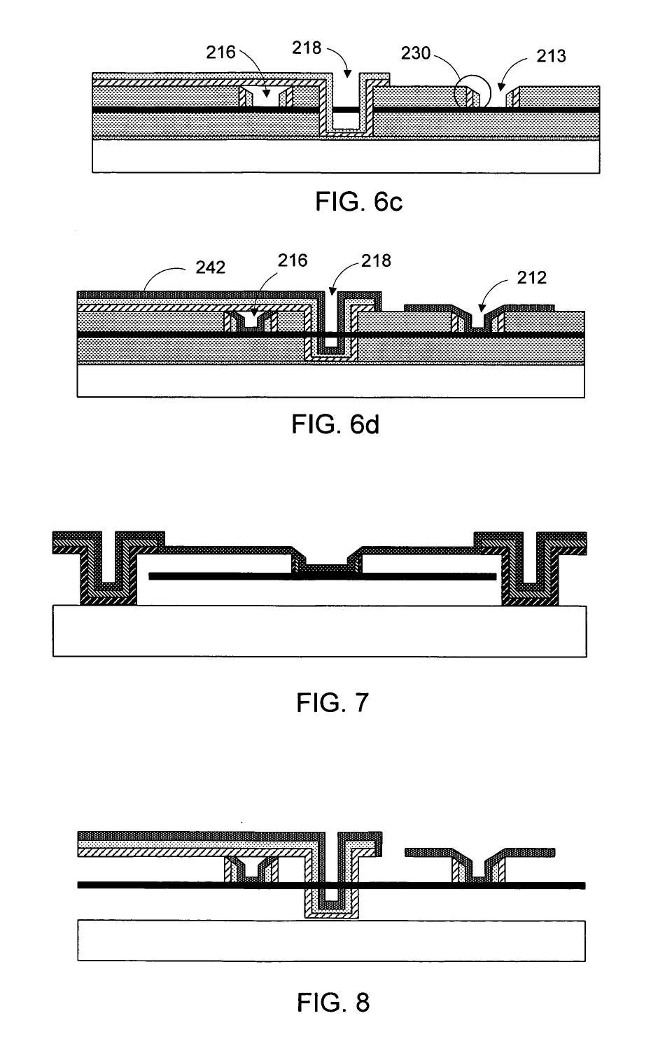

As a way of example, a process flow for fabricating the micromirror as shown in FIG. 3 will be discussed in the following with reference to FIGS. 6a to 6d. Referring to FIG. 6a, substrate 116 is provided. First sacrificial layer 232 is deposited on the substrate followed by the deposition of mirror plate layer 230. The substrate can be glass (e.g. 1737F, Eagle 2000), quartz, Pyrex™, or sapphire. The substrate may also be a semiconductor substrate (e.g. silicon substrate) with one or more actuation electrodes and/or control circuitry (e.g. CMOS type DRAM) formed thereon. The first sacrificial layer may be any suitable material, such as amorphous silicon, or could alternatively be a polymer or polyimide, or even polysilicon, silicon nitride, silicon dioxide, etc. depending upon the choice of sacrificial materials, and the etchant selected. If the first sacrificial layer is amorphous silicon, it can be deposited at 300-350° C. The thickness of the first sacrificial layer can be wide ranging depending upon the size of the micromirror device and desired maximum rotation angle of the mirror plate of the micromirror device, though a thickness of from 500 Å to 50,000 Å, preferably around 10,000 Å, is preferred. The first sacrificial layer may be deposited on the substrate using any suitable method, such as LPCVD or PECVD.

As an alternative feature of the embodiment, an anti-reflection layer (not shown) maybe deposited on the surface of the substrate. The anti-reflection layer is deposited for reducing the reflection of the incident light from the surface of the substrate. Other optical enhancing layers may also be deposited on either surface of the glass substrate as desired. In addition to the optical enhancing layers, an electrical conducting layer can be deposited on a surface of the substrate. This electrical conducting layer can be used as an electrode for driving the mirror plate to rotate, especially to an OFF state.

After depositing the first sacrificial layer, mirror plate 230 is deposited and patterned on the first sacrificial layer. Because the micromirror is designated for reflecting incident light in the spectrum of interest (e.g. visible light spectrum), it is preferred that the micromirror plate layer comprises of one or more materials that exhibit high reflectivity (preferably 90% or higher) to the incident light. The thickness of the micromirror plate can be wide ranging depending upon the desired mechanical (e.g. elastic module), the size of the micromirror, desired ON state angle and OFF state angle, and electronic (e.g. conductivity) properties of the mirror plate and the properties of the materials selected for forming the micromirror plate. In an embodiment of the invention, the mirror plate is a multi-layered structure, which comprises a SiOₓ layer with a preferred thickness around 400 Å, a light reflecting layer of aluminum with a preferred thickness around 2500 Å, and a titanium layer with a preferred thickness around 80 Å. In addition to aluminum, other materials, such as Ti, AlSiCu and TiAl, having high reflectivity to visible light can also be used for the light reflecting layer. These mirror plate layers can be deposited by PVD at a temperature preferably around 150° C.

After deposition, the mirror plate layer is patterned into a desired shape, such as that in FIG. 3. The patterning of the micromirror can be achieved using standard photoresist patterning followed by etching using, for example CF4, C12, or other suitable etchant depending upon the specific material of the micromirror plate layer.

Following the patterning mirror plate 230, second sacrificial layer 234 is deposited on the mirror plate 230 and first sacrificial layer 232. The second sacrificial layer may comprise amorphous silicon, or could alternatively comprise one or more of the various materials mentioned above in reference to the first sacrificial layer. First and second sacrificial layers need not be the same, though are the same in the preferred embodiment so that, in the future, the etching process for removing these sacrificial materials can be simplified. Similar to the first sacrificial layer, the second sacrificial layer may be deposited using any suitable method, such as LPCVD or PECVD. In the embodiment of the invention, the second sacrificial layer comprises amorphous silicon deposited around 350° C. The thickness of the second sacrificial layer can be on the order of 9000 Å, but may be adjusted to any reasonable thickness, such as between 2000 Å and 20,000 Å depending upon the desired distance (in the direction perpendicular to the micromirror plate and the substrate) between the micromirror plate and the hinge. It is preferred that the hinge and mirror plate be separated by a gap with a size from 0.15 to 0.45 microns, more preferably from 0.15 to 0.25 micron, and more preferably from 0.25 to 0.35 microns, and more preferably from 0.35 to 0.45 microns.

In the preferred embodiment of the invention, the micromirror plate comprises aluminum, and the sacrificial layers (e.g. the first and second sacrificial layer) are amorphous silicon. This design, however, can cause defects due to the diffusion of the aluminum and silicon, especially around the edge of the mirror plate. To solve this problem, a protection layer (not shown) maybe deposited on the patterned micromirror plate before depositing the second sacrificial silicon layer such that the aluminum layer can be isolated from the silicon sacrificial layer. This protection may or may not be removed after removing the sacrificial materials. If the protection layer is not to be removed, it is patterned after deposition on the mirror plate.

The deposited second sacrificial layer is then patterned for forming two deep-via areas 218, shallow via area 216 and mirror-extension via 213 using standard lithography technique followed by etching, as shown in the figure. The etching step may be performed using Cl₂, BCl₃, or other suitable etchant depending upon the specific material(s) of the second sacrificial layer. The distance across the two deep-via areas depends upon the length of the defined diagonal of the micromirror plate. In an embodiment of the invention, the distance across the two deep-via areas after the patterning is preferably around 10 μm, but can be any suitable distance as desired. In order to form the shallow-via area, an etching step using CF₄ or other suitable etchant may be executed. The shallow-via area, which can be of any suitable size, is preferably on the order of 2.2 microns. And the size of each deep-via is around 0.5 micron.

After patterning the second sacrificial layer, hinge support layers 236 and 238 are deposited on the patterned second sacrificial layer, as shown in FIG. 6b. Because the hinge support layers are designated for holding the hinge and the mirror plate attached therewith such that the mirror plate can rotate, it is desired that the hinge support layers comprise of materials having at least large elastic modulus. According to an embodiment of the invention, layer 236 comprises a 400 Å thickness of TiNₓ (although it may comprise TiNₓ, and have a thickness between 100 Å and 2000 Å) layer deposited by PVD, and a 3500 Å thickness of SiNₓ (although the thickness of the SiNₓ layer may be between 2000 Å and 10,000 Å) layer 238 deposited by PECVD. Of course, other suitable materials and methods of deposition may be used (e.g. methods, such as LPCVD or sputtering). The TiNₓ layer is not necessary for the invention, but provides a conductive contact surface between the micromirror and the hinge in order to, at least, reduce charge-induced stiction.

After the deposition, layers 236 and 238 are patterned into a desired configuration, as shown in FIG. 6c. The mirror stops, such as the mirror stops corresponding to the “ON” state and/or mirror stops corresponding to the “OFF” state can also be configured. An etching step using one or more proper etchants is then performed afterwards. In particular, the layers can be etched with a chlorine chemistry or a fluorine chemistry where the etchant is a perfluorocarbon or hydrofluorocarbon (or SF₆) that is energized so as to selectively etch the hinge support layers both chemically and physically (e.g. a plasma/RIE etch with CF₄, CHF₃, C₃F₈, CH₂F₂, C₂F₆, SF₆, etc. or more likely combinations of the above or with additional gases, such as CF₄/H₂, SF6/Cl₂, or gases using more than one etching species such as CF₂Cl₂, all possibly with one or more optional inert diluents). Different etchants may, of course, be employed for etching each hinge support layer (e.g. chlorine chemistry for a metal layer, hydrocarbon or fluorocarbon (or SF₆) plasma for silicon or silicon compound layers, etc.).

After etching the hinge support layers, two posts 218 (the two posts are overlapped in the figure), hinge contact area 216 and mirror-extension via 213 are formed. The bottom segments of hinge contact area 216 and mirror-extension via 213 are removed by etching and a part of the mirror plate underneath the hinge contact area is thus exposed. The exposed parts of the mirror plate will be used to form an electric-contact with external electric source. The sidewalls (e.g. sidewall 240) of the hinge contact area 216 and mirror-extension via are left with residues of layers 236 and 238 after etching. The residue on the sidewalls helps to enhance the mechanical and electrical properties of the hinge that will be formed afterwards.

After the completion of patterning and etching of layers 236 and 238, hinge layer 242 is deposited and then patterned as shown in FIG. 6d. In the embodiment of the invention, the hinge layer is electrically conductive. Examples of suitable materials for the hinge layer are Al, Ir, titanium, titanium nitride, titanium oxide(s), titanium carbide, TiSiNₓ, TaSiNₓ, or other ternary and higher compounds. When titanium is selected for the hinge layer, it can be deposited at 100° C. Alternatively, the hinge layer may comprise of multi-layers, such as 100 Å TiNₓ and 400 Å SiNₓ.

Following the deposition, the hinge layer is patterned using etching for forming the hinge in hinge area 216 and the extension plate in mirror-extension area 212. Similar to the hinge support layers (layers 236 and 238), hinge layer 242 can be etched with a chlorine chemistry or a fluorine chemistry where the etchant is a perfluorocarbon or hydrofluorocarbon (or SF₆) that is energized so as to selectively etch the hinge layers both chemically and physically (e.g. a plasma/RIE etch with CF₄, CHF₃, C₃F₈, CH₂F₂, C₂F₆, SF₆, etc. or more likely combinations of the above or with additional gases, such as CF₄/H₂, SF₆/Cl₂, or gases using more than one etching species such as CF₂Cl₂, all possibly with one or more optional inert diluents). Different etchants may, of course, be employed for etching each hinge layer (e.g. chlorine chemistry for a metal layer, hydrocarbon or fluorocarbon (or SF₆) plasma for silicon or silicon compound layers, etc.).

Finally, the micromirror device is released by removing the sacrificial layers using proper etching process with selected etchants. The release etching utilizes an etchant gas capable of spontaneous chemical etching of the sacrificial material, preferably isotropic etching that chemically (and not physically) removes the sacrificial material. Such chemical etching and apparatus for performing such chemical etching are disclosed in U.S. patent application Ser. No. 09/427,841 to Patel et al. filed Oct. 26, 1999, and in U.S. patent application Ser. No. 09/649,569 to Patel at al. filed Aug. 28, 2000, the subject matter of each being incorporated herein by reference. Preferred etchants for the release etch are gas phase fluoride etchants that, except for the optional application of temperature, are not energized. Examples include HF gas, noble gas halides such as xenon difluoride, and interhalogens such as IF₅, BrCl₃, BrF₃, IF₇ and ClF₃. The release etch may comprise additional gas components such as N₂ or an inert gas (Ar, Xe, He, etc.). In this way, the remaining sacrificial material is removed and the micromechanical structure is released. In one aspect of such an embodiment, XeF₂ is provided in an etching chamber with diluents (e.g. N₂ and He). The concentration of XeF₂ is preferably 8 Torr, although the concentration can be varied from 1 Torr to 30 Torr or higher. This non-plasma etch is employed for preferably 900 seconds, although the time can vary from 60 to 5000 seconds, depending on temperature, etchant concentration, pressure, quantity of sacrificial material to be removed, or other factors. The etch rate may be held constant at 18 Å/s/Torr, although the etch rate may vary from 1 Å/s/Torr to 100 Å/s/Torr. Each step of the release process can be performed at room temperature.

In addition to the above etchants and etching methods mentioned for use in either the final release or in an intermediate etching step, there are others that may also be used by themselves or in combination. Some of these include wet etches, such as ACT, KOH, TMAH, HF (liquid); oxygen plasma, SCCO₂, or super critical CO₂ (the use of super critical CO₂ as an etchant is described in U.S. patent application Ser. No. 10/167,272, which is incorporated herein by reference). Of course, the etchants and methods selected should be matched to the sacrificial materials being removed and the desired materials being left behind.

FIG. 7 illustrates a cross-sectional view of the micromirror device after releasing. And FIG. 8 illustrates a side view of the same micromirror device of FIG. 7.

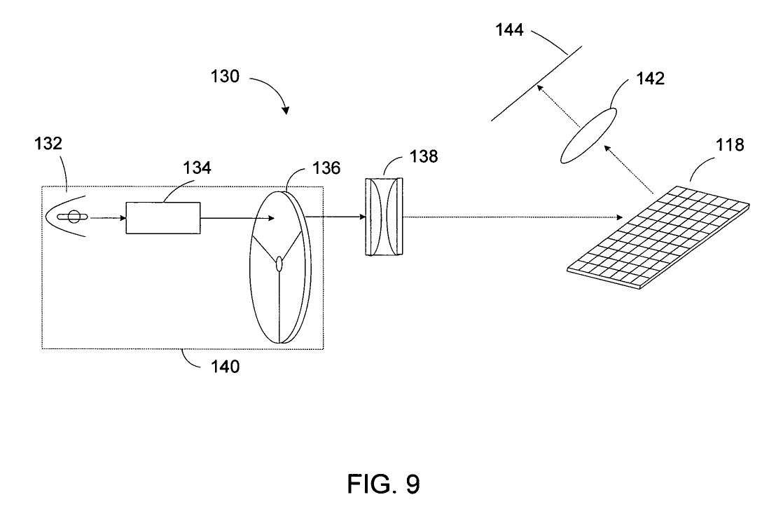

The micromirror array such as that shown in FIG. 2 has many applications. For example, the micromirror array can be used in spatial light modulators of display systems, an example of which is illustrated in FIG. 9. In its basic configuration, display system 130 comprises illumination system 140, optical elements 138 and 142, spatial light modulator 118, and display target 144.

The illumination system provides primary color light that are sequentially applied to the spatial light modulator. In an exemplary configuration, the illumination system light source 132, which can be an arc lamp, lightpipe 134 that can be any suitable integrator of light or light beam shape changer, and color filter 136, which can be a color wheel. In this particular configuration, the color wheel is positioned after the light source and lightpipe on the propagation path of the illumination light from the light source. Of course, other optical configurations can also be used, such as placing the color wheel between the light source and the lightpipe. Optical element 138, which can be a condensing lens, directs the primary color light onto the spatial light modulator in which the primary color light is reflected either into or away from projection lens 142 so as to generate a desired image pattern in the display target. The set of primary colors can comprise any set of three or more colors used to render the output image.

It will be appreciated by those of skilled in the art that a new and useful method for lubricating microstructure devices in packages has been described herein. In view of many possible embodiments to which the principles of this invention may be applied, however, it should be recognized that the embodiments described herein with respect to the drawing figures are meant to be illustrative only and should not be taken as limiting the scope of invention. Those of skill in the art will recognize that the illustrated embodiments can be modified in arrangement and detail without departing from the spirit of the invention. Therefore, the invention as described herein contemplates all such embodiments as may come within the scope of the following claims and equivalents thereof. In the claims, only elements denoted by the words “means for” are intended to be interpreted as means plus function claims under 35 U.S.C. §112, the sixth paragraph.

We claim:

1. A microelectromechanical device, comprising two contacting surfaces due to an impact of one surface against another, wherein at least one of the two surfaces comprises a layer of a material that is a) a mono-ether or thio-ether; b) amine, phosphine, or borane; c) fluorinated organic material containing a ring structure; or d) a silane having four substituent groups, represented by R₁R₂R₃R₄Si, wherein R₁ to R₄ are bonded to Si and are independently alkyl groups.

2. The device of claim 1, wherein the material is a mono-ether or thio-ether.

3. The device of claim 2, wherein the mono-ether is unfluorinated.

4. The device of claim 2, wherein the mono-ether is partially fluorinated.

5. The device of claim 2, wherein the mono-ether is fully fluorinated.

6. The device of claim 2, wherein one of the two surfaces is a surface of a deflectable mirror plate.

7. The device of claim 1, wherein the material is amine, phosphine, or borane.

8. The device of claim 7, wherein the amine is perfluorinated.

9. The device of claim 8, wherein the perfluorinated amine is C₁₅F₃₃N.

10. The device of claim 8, wherein the perfluorinated amine is C₁₂F27N.

11. The device of claim 8, wherein the perfluorinated amine is C₁₈F₃₉N.

12. The device of claim 8, wherein the perfluorinated amine is asymmetric around the nitrogen.

13. The device of claim 1, wherein the material is a fluorinated organic material containing a ring structure.

14. The device of claim 13, wherein the fluorinated organic material comprises perfluoromethyldecalin.

15. The device of claim 13, wherein the fluorinated organic material comprises perfluoroperhydrofluorene.

16. The device of claim 13, wherein the fluorinated organic material comprises perfluorotetradecahydrophenanthrene.

17. The device of claim 13, wherein the fluorinated organic material comprises perfluorophenanthrene.

18. The device of claim 13, wherein fluorinated organic material comprises a triazine.

19. The device of claim 18, wherein the triazine is C₁₂F₂₁N₃.

20. The device of claim 18, wherein the triazine is C₂₄F₄₅N₃.

21. The device of claim 18, wherein the triazine is C₃₀F₅₇N₃.

22. The device of claim 1, wherein the material is a silane having four substituent groups, R₁R₂R₃R₄Si, wherein R₁ to R₄ are bonded to Si and are independently alkyl groups.

23. The device of claim 22, wherein the layer comprises a tetraperfluoroalkylsilane.

24. The device of claim 23, wherein the layer comprises tetramethylsilane.

25. The device of claim 22, wherein the R₁ to R₄ are labile groups that do not hydrolyze.

26. The device of claim 22, wherein at least one of the R₁ to R₄ groups is different from the others.

27. The device of claim 22, wherein each R₁ to R₄ groups comprises 1 to 6 carbons.

28. The device of claim 22, wherein at least one of the R₁ to R₄ groups is partially fluorinated.

29. The device of claim 22, wherein at least one of the R₁ to R₄ groups is fully fluorinated.

30. The device of claim 1, wherein said material layer of said one of two surfaces is not covalently bonded to said surface.

31. A microelectromechanical device package, comprising:
a package substrate having a supporting surface on which a microelectromechanical device is held, wherein the microelectromechanical device is the microelectromechanical device of claim 1; and
a light transmissive lid in connection with the package substrate such that the microelectromechanical device can be sealed within a space formed by the package substrate and the lid.

32. A projection system, comprising:
an illumination system providing light for the system;
a spatial light modulator having a microelectromechanical device of claim 1, wherein the microelectromechanical device comprises an array of micromirrors, and one of the two contacting surface is a surface of a deflectable mirror plate of a micromirror.
